(19) United States
(12) Patent Application Publication
(10) Pub. No.: US 2016/0078502 A1
(43) Pub. Date: Mar. 17, 2016

(54) SYSTEM AND METHOD FOR REVIEWING AND RATING CORPORATE TRAVEL AND MEETING SITES

(71) Applicant: KLIO Travel Ventures, LLC, Marblehead, MA (US)

(72) Inventor: Hervé SEDKY, Marblehead, MA (US)

(73) Assignee: KLIO TRAVEL VENTURES, LLC, Marblehead, MA (US)

(21) Appl. No.: 14/852,040

(22) Filed: Sep. 11, 2015

Related U.S. Application Data
(60) Provisional application No. 62/048,982, filed on Sep. 11, 2014.
(60) Provisional application No. 62/048,979, filed on Sep. 11, 2014.

(51) Int. Cl. G06Q 30/02

(52) U.S. Cl. CPC G06Q 30/0282

(57) ABSTRACT

Systems and methods for providing reviews and ratings on a corporate travel site are provided. A user may purchase services from a supplier using the system. The system may solicit feedback from the user. The user may provide feedback tailored to the services utilized by the user.

### RELATED APPLICATIONS

This application relates to and claims priority under 35 U.S.C. §119(e) to U.S. Provisional Patent Application No. 62/048,979, titled “COMPUTER-IMPLEMENTED SYSTEM AND METHOD FOR MEETINGS DISTRIBUTION SYSTEM AND METHOD,” which was filed on Sep. 11, 2014 and is hereby incorporated by reference herein in its entirety, and to U.S. Provisional Patent Application No. 62/048,982, titled “A COMPUTER-IMPLEMENTED SYSTEM AND METHOD FOR REVIEWING AND RATING CORPORATE TRAVEL AND MEETING SITES,” which was filed on Sep. 11, 2014 and is hereby incorporated by reference herein in its entirety.

### TECHNICAL FIELD

The field of the invention is generally enterprise software, and more specifically review aggregating software for travel and meeting sites.

### BACKGROUND

The market for providing services and accommodations to corporate customers is crowded with suppliers. In particular, businesses today face difficult challenges when selecting service providers across many industries, including travel accommodations and special event venues. In the field of meeting and event planning, no single, coordinated system exists to allow a system user to check availability, price hotel rooms or event space, or shop or transact in any automated way. In addition, suppliers of meeting and event venues are flooded with spam from companies that never intend to actually book their services. Accordingly, there is a need for a systems and methods to review and provide feedback about their experiences with suppliers so that corporate and other users may make informed selections of the services that best fit their corporate structure and stakeholder needs.

### SUMMARY OF THE INVENTION

The present invention is directed to systems and methods for enabling corporate travel system users to provide timely review and feedback so that corporations may better understand the most effective and efficient services to provide its employees related to meeting and event services, and travel services commensurate with the corporation's culture and goals.

In some embodiments, the system and method of the present invention are directed to providing review and feedback capabilities for a corporate travel system that may include receiving, from an administrative module, an indication of services from a particular supplier purchased by a system user, and then determining, using the administrative module, that the services have been completed. Next, the system of the present invention sends, using the administrative module, a request for review and feedback related to the system user's experience related to the services. The system user will provide the requested review and feedback, and the system will store the review and feedback from the system user. The review and feedback will be tagged to the supplier in the storage database of the system.

The administrators of the corporation that run the corporate travel system and event and meeting planning services will use the tagged information to filter future use of suppliers for providing travel services and event and meeting services to stakeholders. The method present invention also enables suppliers that have been tagged with negative reviews and feedback to be notified of same so that they can provide some explanation as to the accuracy of the negative review and feedback, or take corrective actions in view of the negative review or feedback.

These and other capabilities of the disclosed subject matter will be more fully understood after a review of the following figures, detailed this description, and claims. It is to be understood that the phraseology and terminology employed herein are for the purpose of description and should not be regarded as limiting.

### BRIEF DESCRIPTION OF FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 shows a system diagram of a meeting distribution system in accordance with some embodiments of the present invention.

FIG. 2 shows an expanded system diagram of the components of the meeting distribution system in accordance with some embodiments of the present invention.

FIG. 3 shows a flowchart for a method of providing a meeting distribution system in accordance with some embodiments of the present invention.

FIG. 4 shows a flowchart for a method of providing price negotiation in a meeting distribution system in accordance with some embodiments of the present invention.

FIG. 5 shows a system diagram of a review and rating system in accordance with some embodiments of the present invention.

FIG. 6 shows an expanded system diagram of the components of the review and rating system in accordance with some embodiments of the present invention.

FIG. 7 shows a system overview detailing elements of the system accordance with some embodiments of the present invention.

FIG. 8 shows a flowchart for a method of providing the review and rating system in accordance with some embodiments of the present invention.

### DETAILED DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

The present invention is directed to systems and methods for enabling corporate travel system users to provide timely review and feedback so that corporations may better understand the most effective and efficient services to provide their employees related to meeting and event services, and travel services commensurate with the corporation's culture and goals.

More specifically, embodiments of the present invention are directed to a computer-implemented system and method for corporate travelers and meeting attendees to rate hotels, airlines, meeting venues, ground transportation providers, and travel management companies on the services they provide. The evaluation information can be provided in any number of formats. This information may include, but not be limited to, ratings, free-form feedback, and “Would you recommend” questions. Further, this information may evaluate the entire travel experience from service, timeliness, and flexibility to amenities, and at location options. As such, corporations will have the ability to track the satisfaction of their stakeholders (employees and clients) with their suppliers, can more actively manage their supplier community, can resolve problems, and can identify suppliers that do not meet the organizations' standards of service and care for their employees and clients according to their corporate culture and goals. The visibility into the sentiment and feedback of their traveler community will give corporations the ability to better serve their stakeholders.

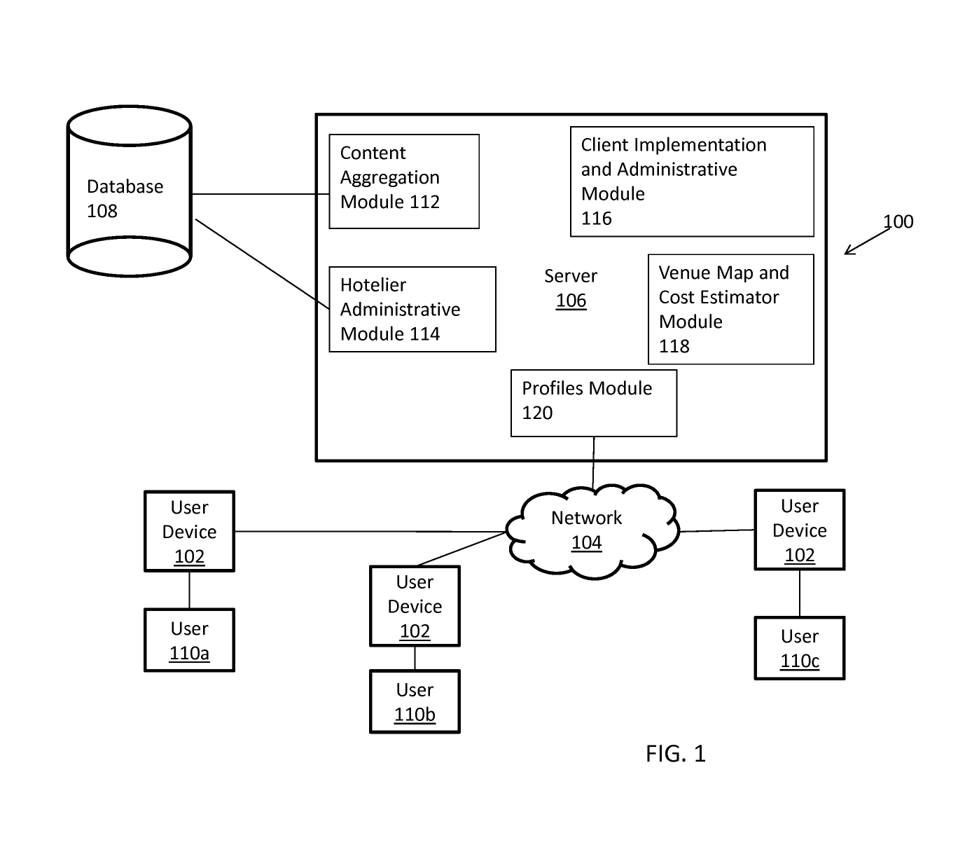

FIG. 1, generally at 100, shows a system diagram that includes the networked system 101, according to some embodiments. Networked system 100 includes user devices 102, network 104, server 106, and database 108. Server 106 further includes Content Aggregation Module 112, Hotelier Administrative Module 114, Client Implementation and Administrative Module 116, Venue Map and Cost Estimator Module 118, and Profiles Module 120.

Preferably, system user devices 102 are in wireless communication with network 104. System user devices 102 can be any device capable of communicating with network 104. For example, system user devices 102 can be a laptop, desktop computer, tablet computer, personal computer, cell phone, including a personal digital assistant (PDA), a smartphone, user equipment, or other device permitting communication between a user and network 104.

As previously indicated, system user devices 102 may be user equipment. This user equipment may communicate with one or more radio access networks and/or with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system, such as Symbian OS, iPhone OS, RIM's Blackberry, Windows Mobile, Linux, HP WebOS, and Android. The screen may be a touch screen that is used to input data to the mobile device, in which case the screen can be used instead of the full keyboard.

One or more user device(s) 102 can include any computing device that is capable of performing computation and is also capable of providing location information. The location information to be obtained by the inclusion of a Global Positioning System (“GPS”) coordinate or a latitude/longitude coordinate. The user equipment discussed above can also keep global positioning coordinates, profile information, or other location information.

Each system user device 102 can send data to, and receive data from, server 106 via communication network 104. Each system user device 102 can be directly coupled to server 106; alternatively, each system user device 102 can be connected to server 106 via any other suitable device, communication network, or combination thereof. For example, each user device 102 can be coupled to server 106 via one or more routers, switches, access points, and/or communication networks (as described below in connection with communication network 104). Each system user device 102 can also include a processor and memory. The memory can be a non-transitory computer readable medium, flash memory, a magnetic disk drive, an optical drive, a programmable read-only memory (PROM), a read-only memory (ROM), or any other memory or combination of memories. The software runs on the processor may be capable of executing computer instructions or computer code. The processor might also be implemented in hardware using an application specific integrated circuit (ASIC), programmable logic array (PLA), field programmable gate array (FPGA), or any other integrated circuit.

System user devices 102 are configured with one or more processors that process instructions and run software that can be stored in memory. The processor also communicates with the memory and interfaces to communicate with other devices. The processor can be any applicable processor such as a system-on-a-chip that combines a CPU, an application processor, and flash memory. User devices 102 also can provide a variety of user interfaces, such as a keyboard, a touch screen, a trackball, a touch pad, and/or a mouse. User devices 102 also can include speakers and a display device in some embodiments.

User devices 102 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities.

System user devices 102 can be utilized by system users 110a-110c to interact with network 104. In some embodiments, system users 110a-110c can be a direct customer, an online travel agency (“OTA”), or a meetings management company (“MMC”). System user 110a can be a direct customer that can enter the system with a login, or a direct customer that utilizes the system without logging in. Direct customers without login credentials can be public users using a computer interface, such as a desktop or mobile interface. A direct customer with login credentials can be corporate and/or public users who register on the computer-based system to create a unique login for accessing the site through the computer interface.

System user 110b can be one of a plurality of OTAs that include corporate users and/or sourcing specialists and meeting planners who utilize the system on behalf of corporate clients.

System user 110c can be a MMC that sources specialists and meeting planners use for employing the system on behalf of corporate clients.

In some embodiments, system user 110a may include a direct customer who logs into the system. In some embodiments, a direct customer with login credentials can shop for venues based on real-time availability and compare availability and the prices of guest rooms, meeting space, F&B bundles, A/V bundles, and amenities, preferably, for up to 5 or more properties across different cities. In some embodiments, a direct customer with login credentials can save an itinerary to compare with a different itinerary at a later stage. A direct customer with login credentials can hold an itinerary to obtain approval, and upload credit card authorization details including scanned images or signed documents. As described herein, the term “hold” refers to registered users with login access holding bookings for a period pre-agreed with hotels while waiting to obtain approval.

In some embodiments, a direct customer with login credentials can book and contract for guest rooms, meeting space, F&B bundles, and A/V bundles, and pay for the booking using a card product or, Automated Clearing House (“ACH”) or Wire Transfer or PayPal. A direct customer with login credentials also can process changes, cancellations, and refunds online.

In some embodiments, system user 110b may be an OTA. In such embodiments, the system user can shop for venues based on real-time availability and compare availability, price of guest rooms, meeting space, F&B bundles, A/V bundles, and amenities. The OTA can hold an itinerary to obtain approval. The OTA can further share an availability report with the corporate meeting owner for approval, and conduct a two-step negotiation process with suppliers on a customer's behalf. The OTA also may book and contract, using a clickthrough contract, for guest rooms, meeting space, F&B bundles, and A/V bundles, or submit a payment request to the corporate meeting owner, or use payment information stored in the meeting owner's profile, or go through a payment approval process, such as, using email with a link to make payments that go to the meeting owner who will either pay or authorize his/her OTA to make the payments using his/her card product. As used herein, the term “request” refers to meeting specifications that are submitted through a customized electronic form by the public, an OTA, or a MMC sourcing specialists and meeting planners.

In some embodiments, the OTA can process changes, cancellations, and refunds online, and send a summary package with budget and contract information to the corporate meeting owner. Further, the OTA can generate real-time meetings reporting by event or generate corporate level reporting on meeting demographics, spending, savings, etc., at the aggregate, business unit, and individual attendee levels. The OTA also can generate benchmark reporting based on like industry, like size, or like maturity of a Strategic Meetings Management (“SMM”) program.

In some embodiments, system user 110c includes a MMC that can shop for venues based on real-time availability. In some embodiments, the MMC can compare availability, price of guest rooms, meeting space, F&B bundles, A/V bundles, and amenities, or hold an itinerary to obtain approval. The MMC can share an availability report with the corporate meeting owner for approval, or, for example, can conduct a two-step negotiation process with suppliers on a customer's behalf. In some embodiments, the MMC can book and contract, using clickthrough contract, for guest rooms, meeting space, F&B bundles, and A/V bundles, or can submit payment request to the corporate meeting owner, use payment information stored in the meeting owner's profile, or go through payment approval process, such as, using email with a link to make payments go to meeting owner who will either pay or authorize an OTA to make the payment using his/her card. Further, the MMC can process changes, cancellations, and refunds online, or can send a summary package with budget and contract information to corporate meeting owner. In some embodiments, the MMC can generate real-time meetings reporting by event, or can generate corporate level reporting on meeting demographics, spend, savings, etc., at the aggregate, business unit, and individual attendee levels. The MMC also may generate benchmark reporting based on like an industry, like size, like maturity of a SMM program.

Network 104 may be a local area network (“LAN”), a wide area network (“WAN”), the Internet, a cellular network, a satellite network, or another network that permits communication between system user devices 102 and server 106. Network 104 can further include one, or any number, of the exemplary types of networks mentioned herein operating as a stand-alone network or in cooperation with each other. Network 104 can utilize one or more protocols of one or more clients or servers to which they are communicatively connected. Network 104 can translate to or from other protocols to one or more protocols of network devices. Although network 104 is depicted as one network, it would be appreciated by a person of ordinary skill in the art that in some embodiments, network 104 may include a plurality of interconnected networks. Other various network types or configurations also can be provided.

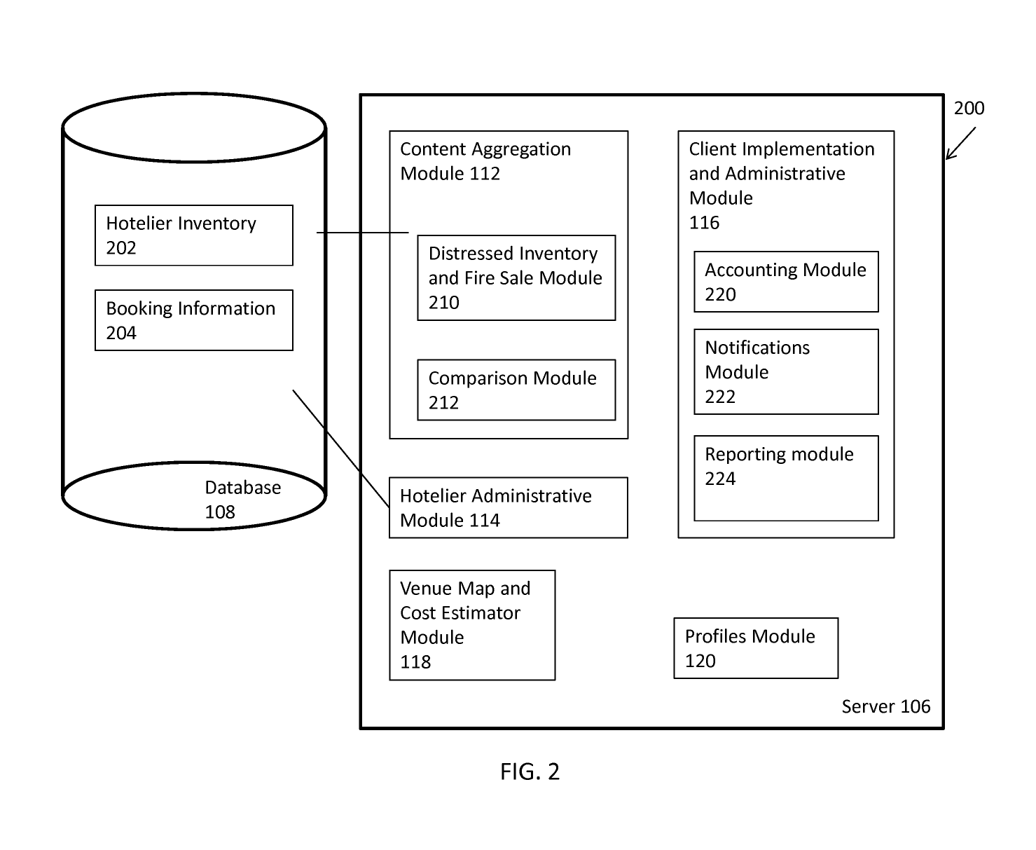

Server 106 can contain modules that implement the meeting distribution system as described more fully in FIG. 2 below. Server 106 contains a plurality of modules, including Content Aggregation Module 112, Hotelier Administrative Module 114, Client Implementation and Administrative Module 116, Venue Map and Cost Estimator Module 118, and Profiles Module 120. Each of these modules and their subcomponents are described more fully with reference to FIG. 2.

Server 106 can operate using any type of operating system (“OS”) software. In some embodiments, the OS software is based on a Linux software kernel and runs specific applications in the server, such as monitoring tasks and providing protocol stacks. The OS software can allow server resources to be allocated separately for control and data paths. For example, certain packet accelerator cards and packet services cards can be dedicated to performing routing or security control functions, while other packet accelerator cards/packet services cards can be dedicated to processing user session traffic. As network requirements change, hardware resources can be dynamically deployed to meet the requirements in some embodiments.

The server software can be divided into a series of tasks that perform specific functions. These tasks communicate with each other as needed to share control and data information throughout server 106. As stated herein, a “task” may be a software process that performs a specific function related to system control or session processing. Preferably, three types of tasks operate within server 106 in some embodiments: critical tasks, controller tasks, and manager tasks. The critical tasks control functions that relate to the server's ability to process calls, such as server initialization, error detection, and recovery tasks. The controller tasks can mask the distributed nature of the software from the system user and perform tasks, such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors can be divided into subsystems. For purposes of the present invention, a “subsystem” is a software element that either performs a specific task or is a culmination of multiple other tasks. A single subsystem can include critical tasks, controller tasks, and manager tasks. Some of the subsystems that run on server 106 include, but are not limited to, a system initiation task subsystem, high availability task subsystem, shared configuration task subsystem, and resource management subsystem.

The system initiation task subsystem may be responsible for starting a set of initial tasks at system startup and providing individual tasks as needed. The high availability task subsystem works in conjunction with the recovery control task subsystem to maintain the operational state of server 106 by monitoring the various software and hardware components of server 106. The recovery control task subsystem can be responsible for executing a recovery action for failures that occur in server 106 and receives recovery actions from the high availability task subsystem. Processing tasks can be separated into multiple instances running in parallel so that if an unrecoverable software fault occurs, the entire processing capabilities for that task are not lost. User session processes can be sub-grouped into collections of sessions so that if a problem is encountered in one sub-group users, in another sub-group will not be affected by that problem.

The shared configuration task subsystem can provide server 106 with an ability to set, retrieve, and receive notification of server configuration parameter changes and is responsible for storing configuration data for the applications running within server 106. The resource management subsystem can be responsible for assigning resources (e.g., processor and memory capabilities) to tasks and for monitoring the task's use of the resources.

FIG. 2, generally at 200, shows an expanded view of the various modules 112, 114, 116, 118, and 120, and their subcomponents implemented within server 106 from FIG. 1. As shown in FIG. 2, server 106 contains Content Aggregation Module 112, Hotelier Administrative Module 114, Client Implementation and Administrative Module 116, Venue Map and Cost Estimator Module 118, and Profiles Module 120. Preferably, server 106 interfaces with database 108. Database 108 contains Hotelier Inventory 202 and Booking Information 204.

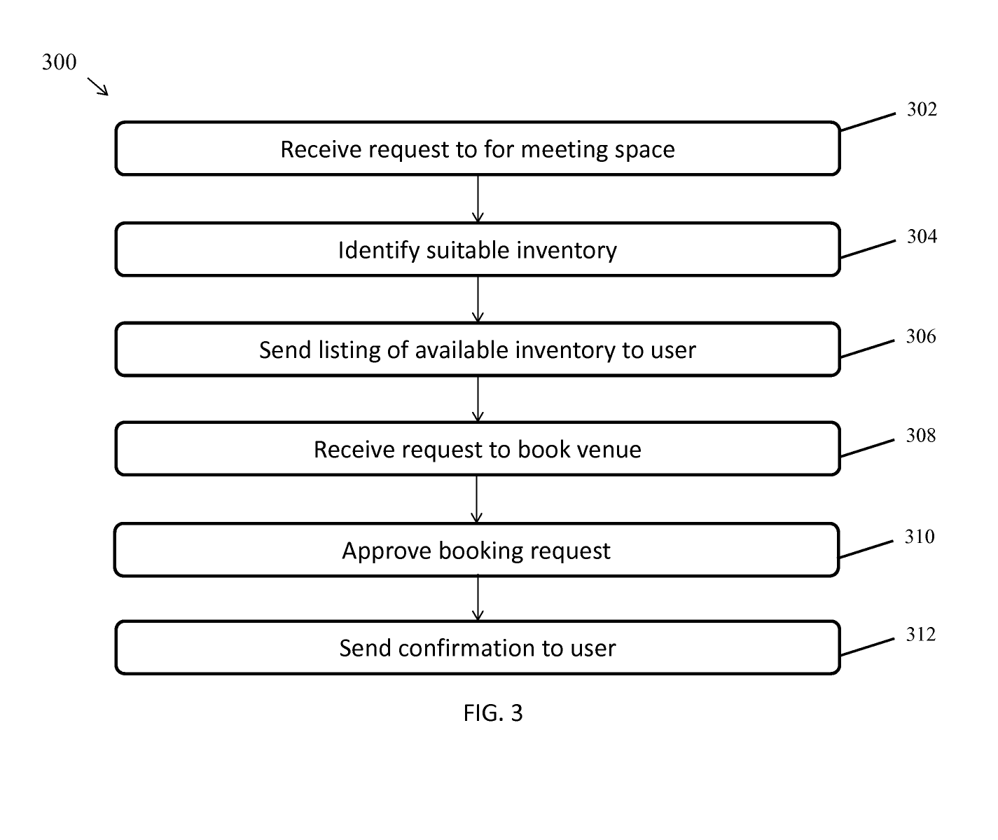

Content Aggregation Module 112 is a module within server 106 configured to acquire venue inventory and handle requests for inventory by system users. Content Aggregation Module 112 can contain Distressed Inventory and Fire Sale Module 210 and Comparison Module 212. Distressed Inventory and Fire Sale Module 210 can allow system users or venues to quickly generate contracts for distressed venues. Comparison Module 212 can allow system users to search and compare available venues prior to booking Content Aggregation Module 112 can be configured to execute the computerized method described in FIG. 3.

Content Aggregation Module 112 can provide the core functionality of the meeting distribution system (“MDS”:). Content Aggregation Module 112 can receive requests for availability, pricing, and amenities from system users, e. g. , system users 110a-110c. In one embodiment, system users 110a-110c can shop for available venues based on real-time availability. When a system user shops for available venues, the system can identify available venues in real time, together with guest rooms meeting space, and F&B and A/V bundle pricing.

In some embodiments, Content Aggregation Module 112 can permit system users 110a-110c to view marketing and promotions from registered suppliers, and compare availability and prices of guest rooms, meeting spaces, F&B bundles, A/V bundles, and amenities for a threshold number of properties for any given city. As used herein, the term “compare” refers to the system presenting, in real-time, available venues, together with guest room, meeting space, and F&B and A/V bundle pricing. In some embodiments, system users 110a-110c can access Content Aggregation Module 112 to book and contract for guest rooms, meeting space, F&B bundles, and A/V bundles. Further, Content Aggregation Module 112 can permit system users 110a-110c to pay for a booking using a card product, e.g., credit, debit or prepaid card, and process changes, cancellations, and refunds online

Content Aggregation Module 112 also can aggregate content from inventory management systems. Inventory management systems are systems that store inventory information from venues. This information will be collected and stored in database 108 as Hotelier Inventory 202. Hotelier Inventory 202 contains all data associated with individual guest rooms, meeting spaces, catering, F&B inventory, and A/V inventory systems at the property level for venues that make use of the system.

In some embodiments, Content Aggregation Module 112 can source corporate-negotiated rates from database 108 for customers with negotiated rates for guest rooms, meeting space, F&B and A/V bundles. In other embodiments, Content Aggregation Module 112 can push availability, pricing, and amenity information to a comparative matrix, which (1) in the public view is shared directly with end users and (2) in the corporate views is pushed to the OTA or MMC to share with the meeting owner.

In some embodiments, Content Aggregation Module 112 can save transactional data in database 108 as it is generated by system users for reporting, benchmarking, regulatory, and safety and security purposes. The saved transactional data can include, for example, spend and save data, spend per attendee, historical rate information, and attendee information including mobile device phone numbers.

Distressed Inventory and Fire Sale Module 210 within Content Aggregation Module 112 can connect to Hotelier Administration Module 114 and allow customers with contracted venues to sell their contracts to other customers, if necessary. In some embodiments, this module permits listing of venues at discounted prices. Distressed Inventory and Fire Sale Module 210 also can allow for the completion of a sale by facilitating payments between seller and buyer. In other embodiments, Distressed Inventory and Fire Sale Module 210 can allow hoteliers to move unsold inventory by, for example, listing venues for discounted prices.

Comparison Module 212 within Content Aggregation Module 112 can allow system users to search and compare available venues prior to booking In some embodiments, the search criteria may include a city, dates of stay, date of meeting, number of guest rooms, number of meeting attendees.

In one example, unregistered system user 110a can compare up to 5 or more properties per city. In this embodiment, registered system user 110a can compare up to 3 or more properties and up to 5 or more cities. In addition, registered system user 110a can save an itinerary for comparison with other itineraries at a later time. Other examples are within the scope of the present invention.

Hotelier Administrative Module 114 is a module within server 106 configured to perform administrative tasks. Hotelier Administrative Module 114 can be configured to connect to Content Aggregation Module 112 and content database 108. Hotelier Administrative Module 114 can upload event-by-event negotiated rates resulting from the MDS negotiations process to database 108 for later use by Content Aggregation Module 112.

Client Implementation and Administrative Module 116 is a module within server 106 configured to act as a security module within server 106. Client Implementation and Administrative Module 116 contains Accounting Module 220, Notifications Module 222, and Reporting Module 224. Accounting Module 220 maintains transaction level financial information for the MDS system. Notifications Module 222 is an email engine that enables OTA and MMC sourcing specialists to send and receive emails through the MDS system. Reporting Module 224 provides reporting on the database 108.

Client Implementation and Administrative Module 116 is an administration module that oversees access to, and security for, the MDS system for all end-user types, and allows for custom configuration of some aspects of the system operation, in addition to facilitating uploading of suppliers or customer-unique data. Client Implementation and Administrative Module 116 also interfaces with, and grants access to, Profiles Module 120, Content Aggregation Module 112, Hotelier Administration Module 114, and Distressed Inventory and Fire Sale Administration Module 210. In controlling access, Client Implementation and Administrative Module 116 supports password management, self-enrollment of users, uploading of preferred suppliers and negotiated rates, and uploading of corporate hierarchy and HR data feeds. The

MDS system also can allow for context sensitive supplier promotions for system users 110a-110c who do not login to the system, and the preferencing of supplier promotions based on tiered pricing.

Accounting Module 220 can maintain transaction level financial information and store the information in database 108. The transaction level financial information can include, for example, fees associated with venue bookings by the public, and OTA and MMC staff. In addition, Accounting Module 220 can calculate commissions from hotels based on agreed upon contracts, and calculate transaction fees from customers, including direct customers, OTAs, and MMCs.

Notifications Module 220 can provide send and receive email capability to OTA and MMC, and system users. Notifications module 220 allows system users to share availability reporting with the corporate meeting owner for approval. In one example, Notification Module 220 permits system users to finalize an itinerary and submit the itinerary to the corporate meeting owner for approval. Further, Notification Module 220 can submit payment requests to the corporate meeting owner and have the meeting owner submit payment information, and can send a summary package with budget and contract information to corporate meeting owner.

Reporting Module 224 provides detailed reporting information for content stored within database 108. In particular, this module can provide reporting on meeting demographics, spending, savings, etc., at the aggregate, business unit, and individual attendee levels. In addition, the module can provide benchmarks on Program Benchmarks, Sourcing Metrics, Main Meeting Types, Chain Behavior, Destination Behavior, and Meeting Size Behavior, as well as create “What if” reporting to determine rates at historical snapshots.

Reporting Module 224 can interface with database 108, which stores information related to inventory (e.g., Hotelier Inventory 202), and information related to bookings (e.g., Booking Information 204). Booking Information 204 may include, for example, information related to individual matched users and venues. In addition to this information, Booking Information 204 can be used by Reporting Module 224 to generate generalized reports that may include overall meeting demographics, amounts spent by system users, savings from the market rate, and individual attendee levels. Database 108 also can be used by Reporting Module 224 to generate benchmarking information. The benchmarking information can include, but not be limited to, Room Night Behavior such as Average Group Rate (“AGR”), Average Room Nights per Program, Meeting Mix Overview; Sourcing Metrics, such as Average Properties Sourced, Times Sourced, Average Lead Days; and Main Meeting Types, such as By Meeting Type: AGR, Average Room Nights per Program. Database 108 can also store chain behavior, including, for example, Main Chains, such as AGR Overview: AGR by Chain. Further, Database 108 can store Destination Behavior, such as Top Destinations: AGR, Room Nights Percentage. Still further, Database 108 can store Meeting Size Behavior By Meeting Size Compared to Peers, and Historical Snapshots, including Event level negotiated pricing information and rate information.

Venue Map and Cost Estimator Module 118 is a module within server 106 that is preferably configured to allow system users to possible venues on a Google map. Although a Google map is mentioned, other map systems are considered within the scope of the invention. Venue Map and Cost Estimator Module 118 can provide detailed location information including geographic areas, as well as, specific locations of client office sites. In addition, this module can allow system users, such as, system users 110a-110c, to estimate the cost of an event within certain parameters.

Profiles module 120 is a module within server 106 that preferably facilitates the booking process by collecting data associated with system user devices 102a-102c. Once the data is collected and stored in database 108, Profile Module 120 can store meeting owner profile information, which eliminates the need to reenter this information for each meeting request into the MDS system. In addition, this feature allows profiles to be created for Executive Assistants and other people in an organization who book meetings on behalf of others to setup their profiles and add the meeting owner's information for the approval workflow.

Profiles module 120 can collect substantial data from system users to assist in the venue matching process. An exemplary list of data that may be collected includes:

1. Event Profile Data, such as Event Name, Event Owner Name, Event Owner Home Company, Event Owner Home Business Unit, Event Owner Contact Email, Event Owner Contact Phone, Event Sourcer, Event Planner, Event Start Date, Event End Date, Event Venue Name, Event Address 1, Event Address 2, Event City, Event State, Event Postal Code, Event Country, and Event Venue Class of Service.

2. Attendee Data, such as Attendee Name, Attendee Title, Attendee Company, Attendee Business Unit, Attendee Phone Number, Attendee Mobile Number, Attendee Emergency Contact Name, Attendee Emergency Contact Phone Number, Attendee Flight Data, Airline 1, Airline 2, Flight Date Segment 1, Flight Date Segment 2, Flight Date Segment 3, Flight Date Segment 4, Flight Date Segment 5, Flight Date Segment 6, Flight Segment 1, Flight Segment 2, Flight Segment 3, Flight Segment 4, Flight Segment 5, and Flight Segment 6.

3. Venue Transactional Data such as Venue Name, Venue Booking Transaction Date, Venue Total Transaction Amount, Venue Cancellation Fees, Venue Attrition Fees, Venue Room Fees, Standard Room (individual and aggregate), VIP Room (individual and aggregate), and Staff Room (individual and aggregate).

4. Venue Meeting Space Fees.

5. Venue Food & Beverage Fees such as Breakfast (individual and aggregate), Morning Break (individual and aggregate), Lunch (individual and aggregate), Afternoon Break (individual and aggregate), Cocktails (individual and aggregate), inner (individual and aggregate).

6. Venue Audio Visual Fees such as Projectors, Cables, Power Strips, Microphones, Amplifiers, and Mixers.

7. Service Fee Data such as Meeting Distribution System Fees, Direct Customer Fees, Mobile Customer Fees, OTA Fees, and MMC Fees.

FIG. 3, generally at 300, shows a computerized method for matching system users and venues in accordance with the MDS of the present invention. Preferably, method 300 includes steps 302, 304, 306, 308, 310, and 312. At step 302, a new request for meeting space is received by the MDS from a system user. At step 304, suitable venue inventory is identified and acquired. At step 306, a listing of available inventory is provided to requesting system user. At step 308, a request to book an available venue is received by the MDS. At step 310, the booking request is approved and logged by the MDS. At step 312, confirmation is sent to the system user and the method ends.

As stated, at step 302, a new request for meeting space is received by the MDS from a system user. More specifically, a system user, such as, system user 110a, 110b, or 110c, associated with a system user device 102 sends a request to locate meeting space via network 104 to server 106. The system user may connect to the MDS system via a desktop or mobile user interface. System user device 102 can be any mobile or desktop device capable of interfacing with MDS 100. The request may include information regarding the system user's needs for the booking including, for example, date and time, pricing, location, and space information.

Again as stated previously, at step 304, venue inventory information can be acquired. Venue inventory information is the set of all inventory available on system 106. In one embodiment, venue inventory information is stored at Hotelier Information 202 of database 108. At this step, the MDS will review all available venues for those venues that meet the needs provided by system user at step 302.

As previously stated, at step 306, available venues are sent to the system user, such as, system users 110a-110c. At this step, all venues that matched the system user's preferences are compiled and provided to the system user to allow the system user to select a match.

As stated, at step 308, the system user can send a notification of a selected venue. In some embodiments, the system user can select a first choice, second choice, and third choice venue in case of a change in availability.

As stated previously, at step 310, the MDS can approve the booking request. At this step, the system user's payment information is processed and the venue is marked in database 108 as no longer available for the selected time.

Again as previously stated, at step 312, a notification indicating a successful booking is sent to the system user, which ends the process.

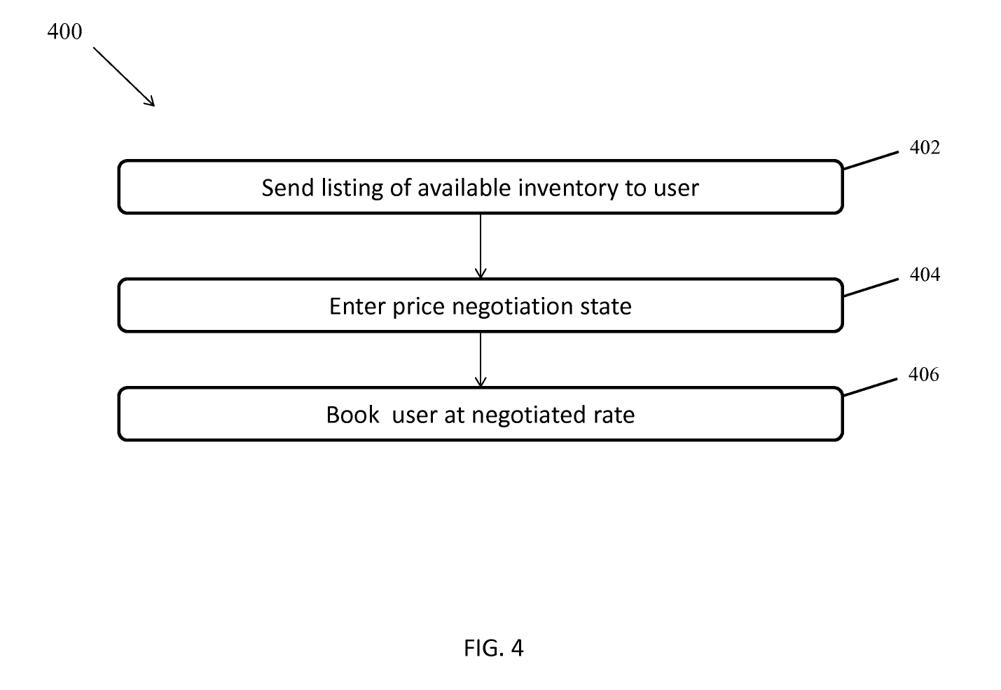

FIG. 4, generally at 400, shows a computerized method for negotiating prices for venues in accordance with the MDS of the present invention. Preferably, method 400 includes steps 402, 404, and 406. At step 402, a listing of available inventory is provided to requesting system user. At step 404, the user and system enter the price negotiation state. At step 406, the booking request is approved at the negotiated rate and logged by the MDS. Steps 402-406 may be executed as an alternative to, or integrated with, steps 306 and 308 in FIG. 3.

As stated, at step 402, available venues are sent to the system user. Preferably, available venues for this method will only be provided to system users that include an OTA or MMC, such as, system users 110b-110c. At this step, all venues that matched the system user's preferences are compiled and provided to the system user to allow the system user to select a match.

As stated, at step 404, the price negotiation state is entered. The price negotiation can be executed at Client Implementation and Administrative Module 116. In this state, the MDS will open communication with the system user to negotiate a mutually agreeable price for a matched venue. In one example, the system can store a list price in Hotelier Inventory 202, and a lowest price for a sale that is less than the list price. The system user can offer a price for one or more venues and attempt to find a suitable venue at a desired price. In one embodiment, the user can submit a highest price that the user will pay for a list of venues, and the MDS can automatically select a matching venue based on the submitted list including the amounts the system user is willing to pay.

As stated previously, at step 406, the MDS can approve and log the booking request. At this step, the system user's negotiated price for the venue is approved based on Hotelier Inventory information 202 stored in database 108. At this step, payment information is processed and the venue is marked in database 108 as no longer available for the selected time.

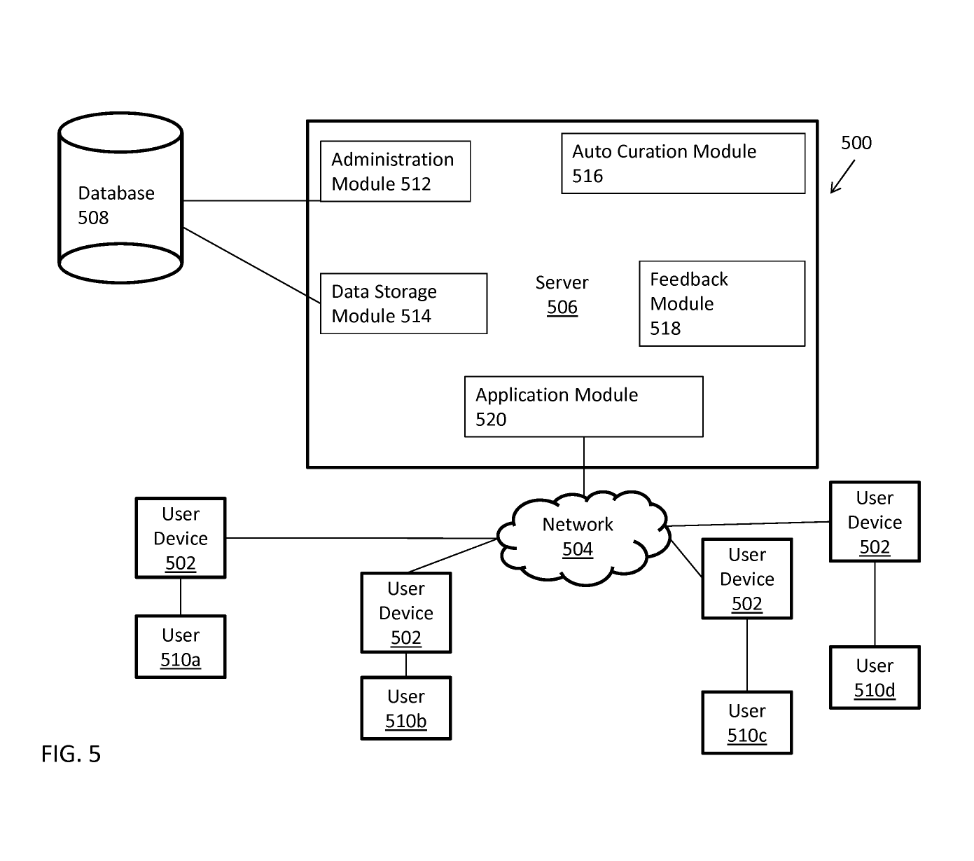

FIG. 5, generally at 500, shows showing the networked system, according to some embodiments, that includes review and feedback information to be provided and processed by the MDS. The MDS configuration FIG. 5 uses some of the modules shown in FIG. 2 and system user devices shown in that Figure. However, the uses of these modules and devices is different as will be described herein for purposes of novel review and feedback of systems, event, and meeting services, and corporate travel systems.

Again referring to FIG. 5 at 500, the system includes system user devices 502, network 504, server 506, and database 508. Server 506 may further include Administrative Module 512, Data Storage Module 514, Auto Curation Module 516, Feedback 518, and Application Module 520.

System user devices 502, similar to system devices 102 in FIG. 1, are in electrical communication with network 504. Preferably, this communication link is wireless, although it could be wired. System user devices 502 can be any device capable of communicating with network 504. Each system user device 502 can send data to, and receive data from, server 506 using communication network 504.

A system user device 502 can be used by system users 510a-510d to interact with network 504 and server 506. In some embodiments, system users 510a-510d can be a direct user, an OTA, an MMC, or a supplier of travel services.

System user 510a can be a direct customer who accesses the system with login credentials, or a direct customer that uses the system without logging in. A direct customer without login credentials can be public users using a computer interface, such as a desktop or mobile device. A direct customer with login credentials can be corporate and/or public users who register on the computer-based system to create a unique login for accessing the site through the computer interface.

System user 510b can be one of a plurality of OTAs including, but not limited to, corporate users and/or sourcing specialists and meeting planners who utilize the system on behalf of corporate clients. System user 510c can be a MMC that sources specialists and meeting planners for employing the system on behalf of corporate clients. System user 510d can be a supplier of travel services to be reviewed and rated.

Users 510a, 510b, and 510c are similar to system users 110a, 110b, and 110c that have been described in more detail in FIG. 1.

As stated, in some embodiments, system user 510d may include a supplier of travel services to be reviewed and rated. If desired, the supplier can generate a verified account by logging into the system. In other embodiments, the supplier can access the MDS without logging in. In one implementation, the supplier includes, for example, hotels, ground transportation companies, travel management companies, airlines, meeting venues and catering companies, and conference centers. If the supplier is verified, the supplier may sign contracts to access the system, and can view feedback, ratings, and respond to them, in addition to running reports regarding the feedback.

If system user 510d is verified, the system user can submit responses to feedback and ratings, and receive alerts regarding negative feedback and ratings. This system user includes suppliers. System user 510d also can place advertisements by category of supplier, location of supplier, and the specific supplier. In other embodiments, system user 510d may gain access to the data in aggregate for research and trending purposes. If unverified, system user 510d only can receive read access the reviews of his/her company.

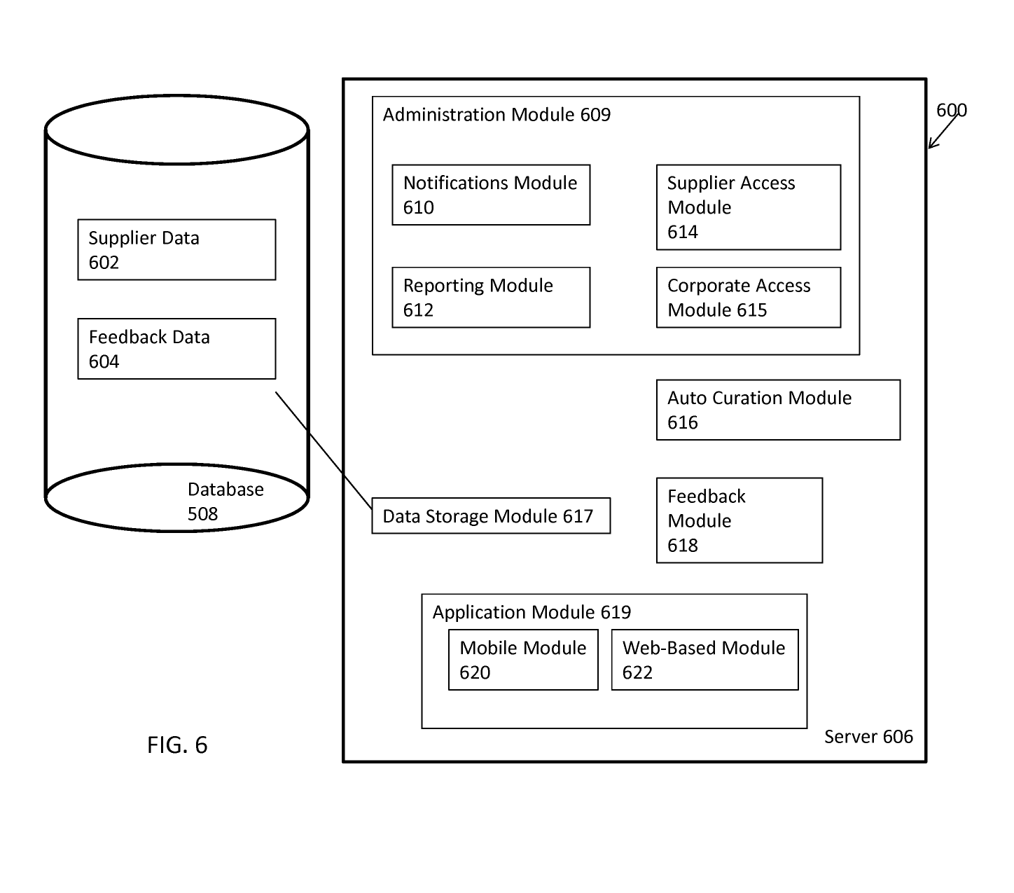

Server 506 may include modules shown in FIG. 5 that implement the MDS and these modules are described more fully in FIG. 6. As such, each of these modules and their subcomponents will now be described with reference to FIG. 6.

FIG. 6, generally at 600, shows an expanded view of the modules 512, 514, 516, 518, and 520 of server 506 and their subcomponents shown in FIG. 5. Generally, server 606 contains Administration Module 609, Data Storage Module 617, Auto Curation Module 616, Feedback Module 618, and Application Module 619. Server 606 can interface with database 508. Database 508 contains Supplier Data 602 and Feedback Data 604.

Administration Module 609 of server 606 may be configured to receive and process all administrative tasks within system 500 (FIG. 5). Administration Module 609 can contain Notifications Module 610, Reporting Module 612, Supplier Access Module 614, and Corporate Access Module 615. Notifications Module 610 can be an email engine for sending notifications to system users. Reporting Module 612 also may be an email engine for sending notifications to system users; however, the notifications will be different from those sent by the Notifications Module. Supplier Access Module 614 may allow member suppliers controlled access to data, reporting, and contact with corporate reviewers. Corporate Access Module 616 can allow a travel manager to access feedback and ratings.

Administration Module 609 may enable backend services to run the feedback system. Administration Module 609 can periodically import names and email addresses from corporate human resources systems and store the data via Data Storage Module 614 in database 508. This module also may manage and schedule site backups, including feedback, ratings, and reviewer and travel manager contact information stored in database 508 as Supplier Data 602 and Feedback Data 604. An administrator also can use Administration Module 609 to directly onboard customers, suppliers and other agencies (e.g., MMCs, OTAs, and travel management companies). In some embodiments, Administration Module 609 can be integrated with the Global Distribution Systems (“GDS”), for example, for airlines to allow for simpler searching for itineraries for which review and feedback are to be provided. Similarly, Administration Module 609 can be integrated with systems of hotels and ground transport, and can further be integrated with supplier portals to permit easier access to itineraries in the system.

Notifications Module 610 within Administration Module 609 can be an email engine for sending notifications to system users 510a, 510b, 510c, or 510d (FIG. 5). In some embodiments, Notifications Module 610 can include a trigger mechanism that will auto-generate email notifications to travel managers and member suppliers when negative feedback or ratings are submitted. These notifications can be generated at fixed or variable times after the completion of a purchased itinerary.

Reporting Module 612 within Administration Module 609 can generate feedback reports specific to different users of the system. In some embodiments, Reporting Module 612 can aggregate reviews for a travel supplier and provide detailed analysis including an average star rating. In one embodiment, Reporting Module 612 can provide, through Application Module 619, a view that aggregates the feedback and ratings to provide the system user with a resource that rates suppliers through the lens of, for example, a corporate traveler. Reporting Module 612 also can permit both verified corporate users and non-verified public users to submit queries regarding the feedback and ratings on specific suppliers and venues. In some embodiments, a system user may purchase a report via Reporting Module 612. In this embodiment, the system user can utilize a payment gateway (not shown) within Administration Module 609 to pay for services. The payment gateway also can be used to process payments for other services, such as membership fees for the system. In one example, the payment gateway can process electronic payments using a card product, an Automated Clearing House (“ACH”), a Wire Transfer, or PayPal.

Supplier Access Module 614 within Administration Module 512 allows member suppliers controlled access to data, reporting, and contact with corporate reviewers. Preferably, suppliers can have access to the system through Supplier Access Module via a front-end, e.g., a Supplier Dashboard. This dashboard can allow suppliers to contact reviewers and travel managers, run reports, conduct research, and respond to reviewers. As such, in some embodiments, Supplier Access Module 614 can allow suppliers to submit responses to reviewer feedback and ratings via email and comment boxes directly below the original review. Suppliers may further gain access to the data, e.g., feedback data 604 stored in database 508, for research and trending purposes and see detailed comments from reviewers.

Corporate Access Module 615 within Administration Module 609 can allow a travel manager to access feedback and ratings by property, chain, geographic location, and reviewer. In some embodiments, Corporate Access Module 615 can allow travel managers to run reports based on criteria discussed previously by making use of Reporting Module 612. In some embodiments, Corporate Access Module 615 can permit access by travel managers and procurement staff to information regarding the health of relationships between their internal customers and suppliers. Preferably, Corporate Access Module 615 can provide feedback through Application Module 619 in a visually appealing interface, including, for example, data and graphs with up-to-date information. It is appreciated that this feature will facilitate the oversight of service quality by generating reports by hotel chain, hotel property, geolocation, and traveler.

Data Storage Module 617 is a module within server 606 configured to receive, aggregate, and store system user feedback and ratings. Data Storage Module 617 can interact with database 508 to store feedback and ratings as Feedback Data 604. As stored by Data Storage Module 617, Feedback Data 604 within database 508 can be retrieved by reviewer name, corporation name, supplier name, geographic location, and rating. Further, Data Storage Module 617 can receive feedback and ratings information from Feedback Module 618, as described below.

As previously stated, Auto Curation Module 616 is a module within server 606 configured to execute quality control on reviews and other feedback. For example, Auto Curation Module 616 can interface with Data Storage Module 617 or Feedback Module 618 to scan system user reviews. A feature of the Auto Curation Module includes scanning feedback that will be auto-curated for inappropriate language. Thus, this module can individually scan each review for inappropriate language, and can reject inappropriate reviews when found.

As discussed previously, Feedback Module 618 is a module within server 606 configured to receive and process feedback from system users. Feedback Module 618 can interface with Application Module 619 to interact with system users. All feedback and ratings will be stored by Feedback Module 618 in database 508. Preferably, that database 508 will store both public and corporate feedback within Feedback Data 604. In some embodiments, Feedback Module 618 can be configured to trigger a notification to suppliers upon receipt of negative feedback or ratings. Preferably, Feedback Module 618 permits both member and nonmember suppliers to be able to respond to reviewers on the system of the present invention. The negative feedback can be forwarded to the appropriate respondent at the property level. If a corporation configures the system and method of the present invention to do so, member suppliers can respond to reviewers directly.

In some embodiments, Feedback Module 618 can provide the top 2 and bottom 2 reviews for a supplier based on ratings. In addition, suppliers can reply to these reviews and their responses will be viewable on the MDS by system users. In some embodiments, if a reply is made to a review not in the top 2 or bottom 2, an email can be sent to the reviewer. The remaining reviews can be sent to Data Storage Module 617 for storage as Feedback Data 604 in database 508.

Application Module 619 can control front-end interactions with system users 110a, 110b, 110c, and 110d. Application Module 619 can contain Mobile Module 620 and Web-Based Module 622. Mobile Module 620 can allow system users to access the MDS from mobile devices. Web-Based Module 622 can allow system users to access the MDS from a web-based front-end, e.g., a computer browser.

In some embodiments, Mobile Module 620 may include, for example, a mobile application native to Microsoft's Windows Phone, Apple's iOS, and Google's Android OSs. In some embodiments, the application can allow system users to provide feedback in the form of ratings, free-form feedback, and “Would you recommend” questions. Mobile Module 620 also can allow system users to submit queries regarding hotels, airlines, meeting venues, ground transportation providers, and travel management companies. These queries can be forwarded for handling to Administration Module 619 for fulfillment by Reporting Module 612. In some embodiments, hotels and meeting venues can be searched by chain, venue, geolocation, and ratings. A corporate page can be provided to initiate a corporate process, and a public page can be provided to initiate the public process.

In some embodiments, Web-Based Module 622 may include a corporate page to initiate a corporate process, and a public page initiates the public process. Mobile Module 620 can further allow system users to provide feedback in the form of ratings, free-form feedback, and “Would you recommend” questions. This feedback can then be transferred to Feedback Module 618 for processing. Mobile Module 620 also can allow system users to submit queries regarding hotels, airlines, meeting venues, ground transportation providers and travel management companies. Hotels and meeting venues can be searched by chain, venue, geolocation, and ratings.

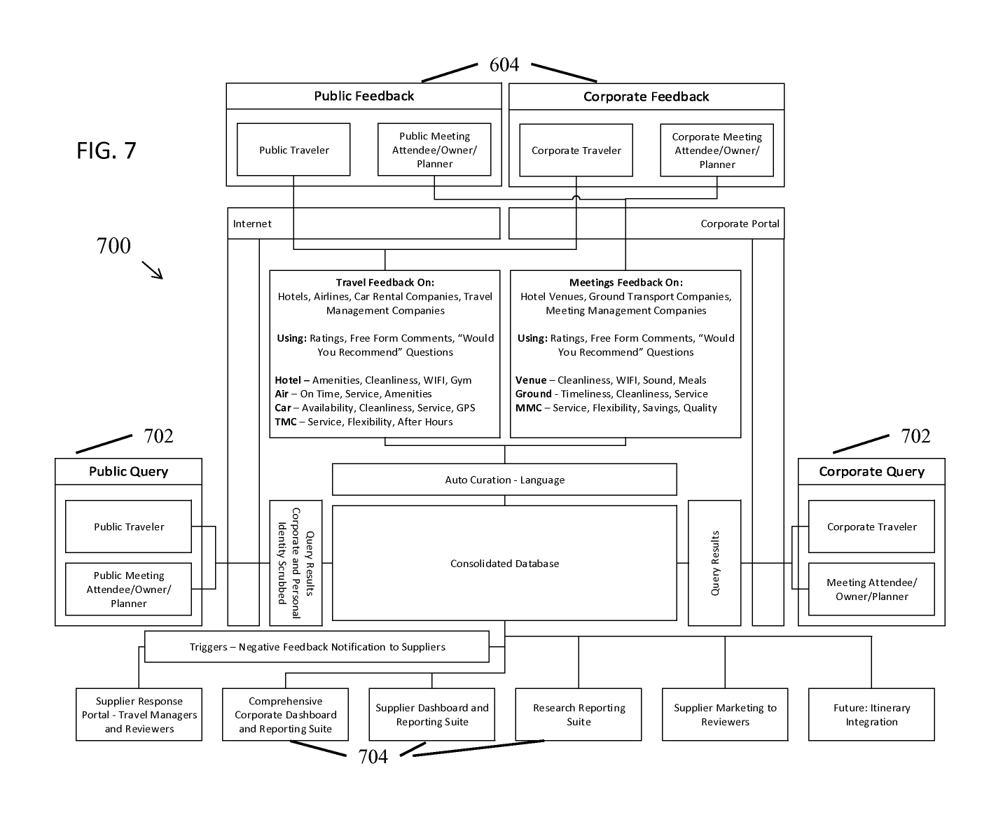

FIG. 7, generally at 700, shows the flow of feedback and queries to the system, according to some embodiments. FIG. 7 contains Feedback Data 604, queries 702, and reporting suites 704.

As shown in FIG. 7, queries 702 may be provided to the system 500 to review feedback for suppliers. Queries can originate from public system users 510a, or corporate users 510b and 510c. Public queries can be provided by, for example, public travelers looking for feedback to book services, such as hotel rooms, or public meeting attendees, owners, or planners looking for feedback to book services such as venues. Corporate queries can be provided by, for example, corporate travelers or corporate meeting attendees, owners, or planners. Queries 702 can be sent to system 500 and fulfilled by Administration Module 609 within server 606.

Reporting suites 704 can be client facing dashboards for interacting with the system 600. Reporting suites 704 can include, for example, a comprehensive corporate dashboard and reporting suite for corporate users, a research reporting suite, and a supplier dashboard and reporting suite for suppliers. The comprehensive corporate dashboard and reporting suite can interface with Corporate Access Module 615 to provide services to corporate users, such as system users 510b or 510c. The research reporting suite can interface with Reporting Module 612 to provide services to public users, such as system users 510a. The supplier dashboard and reporting suite can interface with Supplier Access Module 614 to provide services to suppliers, such as system users 510d. As previously indicated, Supplier Access Module 614 can allow system users 510d to respond to negative feedback when a negative feedback notification is triggered. In addition, supplier dashboard and reporting suite can allow system users 510d to set preferences for marketing directly to system users 510a, 510b, and 510c though Supplier Access Module 614. In one example, this marketing can take the form of ads displayed to system users when providing reviews on the system 600.

Feedback Data 604, as described above in FIG. 6, includes all reviews, feedback, and recommendations from users that have been reported to the system. Feedback Data 604 can be collected from system users via, for example, ratings, free-form comments, and “Would you recommend?” questions. Feedback Data 604 can be separated into public feedback from public users, e.g., users 510a, and corporate feedback from corporate users, e.g., users 510b and 510c. Feedback from public and corporate travelers can be, for example, feedback on hotels, airlines, car rental companies, or travel management companies. Hotels can be reviewed on, for example, amenities, cleanliness, WiFi, and gym facilities. Airlines can be reviewed on, for example, on-time rating, service, and amenities. Car rentals can be reviewed on, for example, availability, cleanliness, service, and GPS availability. Travel management companies can be reviewed on, for example, service, flexibility, and after-hours availability. In some embodiments, feedback can be solicited directly from system users upon completion of an itinerary booked through system 100, as described in FIG. 1.

Feedback from public and corporate meeting attendees, owners, or planners can be, for example, feedback on hotel venues, ground transportation companies, and MMCs. Hotel venues can be reviewed on, for example, cleanliness, WiFi, audio/visual facilities, and meals. Ground transportation companies can be reviewed on, for example, timeliness, cleanliness, and service. MMCs can be reviewed on, for example, service, flexibility, savings, and quality.

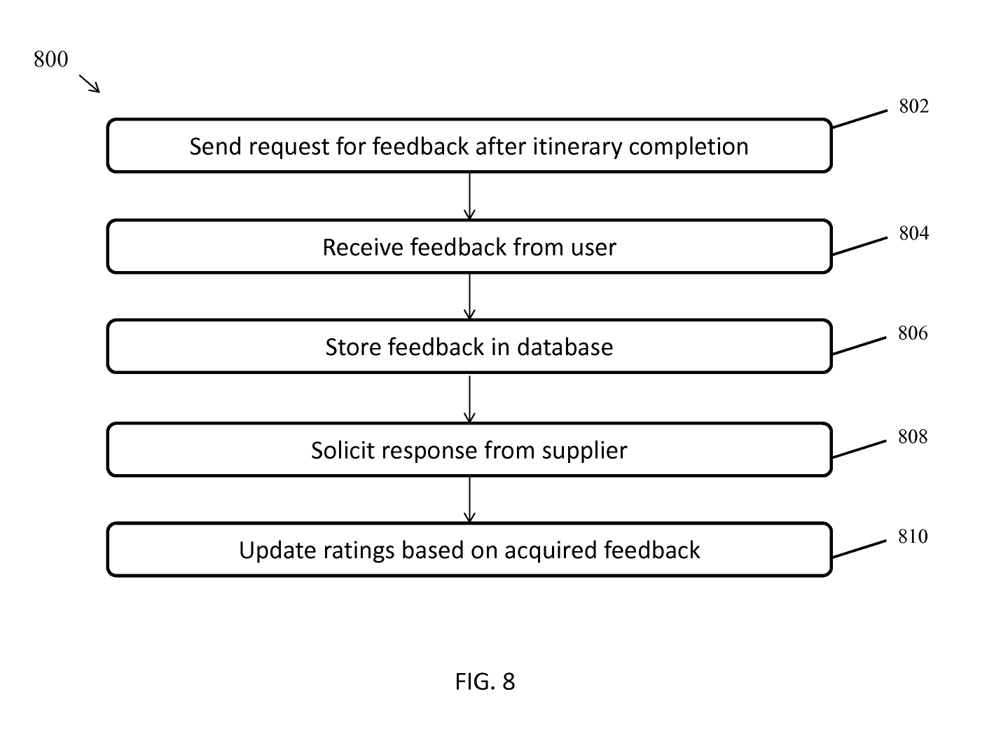

FIG. 8, generally at 800, shows a computerized method for acquiring and storing feedback in accordance with the review and feedback system. This feedback may then be used by corporations for the selection of suppliers. The system also provides means for suppliers to respond to negative feedback.

Again referring to FIG. 8, method 800 contains steps 802, 804, 806, 808, and 810. At step 802, a request for feedback is sent to a system user. At step 804, feedback is sent by the system user to the system. This feedback is received by the system. At step 806, the received feedback is stored in a database. At step 808, a response is solicited from the reviewed supplier. At step 810, ratings for the reviewed supplier are updated.

As previously stated, at step 802, a request for feedback is sent to a user. The request for feedback can be automatically generated upon the completion of services tracked by the booking system. The status of itineraries booked by system users can be stored in database 508. In one example, the status of itineraries can be Booking Information 204 stored in database 108 (FIG. 2), and can be retrieved via network 504 (FIG. 5) from server 506 (FIG. 5). In another example, a request for feedback can be generated by Notifications Module 610 when Administrative Module 609 determines that a traveler has completed a travel itinerary. System user 510a, 510b, 510c or 510d associated with a system user devices 502 can receive the request for feedback via network 504 to server 506. The system user may connect to the MDS via a desktop or mobile-user interface via Application Module 520. System user devices 502 can be any mobile or desktop device capable of interfacing with system 500.

As previously stated, at step 804, feedback can be received from the system user. The desktop or mobile user can connect to the system interface via Application Module 520 (FIG. 5). The feedback should be based on the services provided to the system user by one or more suppliers of services, as described above. In one embodiment, the provided services can be booked via server 106 in FIG. 1.

As previously stated, at step 806, the feedback provided by a system user is stored in the database. Preferably, the feedback provided by the system user will be received at Feedback Module 518 via Application Module 520. Feedback Module 518 can then parse the received feedback and ready the data for storage in database 508. Feedback Module 518 can further send the parsed review to Auto Curation Module 516 for quality control. After Auto Curation Module 516 reviews the data, Feedback Module 518 can transfer the review to Data Storage Module 514, which stores the information in Database 508 as Feedback Data 604.

As previously stated, at step 808, a response from the reviewed supplier can be solicited. Preferably, when Feedback Module 518 receives the review from Auto Curation Module 516, Feedback Module 518 will send a notification to Administration Module 512, which will notify the reviewed supplier via Notifications Module 610 (FIG. 6). The reviewed supplier will then have the opportunity to respond to the feedback via Supplier Access Module 614.

As previously stated, at step 810, once the supplier responds or the time period for responding expires, ratings for the reviewed supplier can be updated. Each supplier in the system will have a profile associated with the supplier and stored as Supplier Data 602 (FIG. 6) of database 508. In the update process, Data Storage Module 617 (FIG. 6) will update raw Feedback Data 604 (FIG. 6) in addition to Supplier Data 602 (FIG. 6) in database 508. In one embodiment, the supplier's updated ratings can be immediately viewable by system users. In another embodiment, the supplier's rating can remain the same until the supplier is provided an opportunity to review the provided feedback. System users 510a, 510b, 510c, and 510d can each subsequently review the updated ratings of suppliers directly or indirectly via reports generated through Reporting Module 612 (FIG. 6).

The embodiments or portions thereof of the system and method of the present invention may be implemented in computer hardware, firmware, and/or computer programs executing on programmable computers or servers that each includes a processor and a storage medium readable by the processor (including volatile and non-volatile memory and/or storage elements). Any computer program may be implemented in a high-level procedural or object-oriented programming language to communicate within and outside of computer-based systems.

Any computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the embodiments. The embodiments or portions thereof may also be implemented as a machine-readable storage medium, configured with a computer program, where, upon execution, instructions in the computer program cause a machine to operate to perform the functions of the embodiments described above.

The embodiments or portions thereof of the system and method of the present invention described above may be used in a variety of applications. Although the embodiments or portions thereof are not limited in this respect, the embodiments or portions thereof may be implemented with memory devices in microcontrollers, general purpose microprocessors, digital signal processors (DSPs), reduced instruction-set computing (RISC), and complex instruction-set computing (CISC), among other electronic components. Moreover, the embodiments, or portions thereof, described above may also be implemented using integrated circuit blocks referred to as main memory, cache memory, or other types of memory that store electronic instructions to be executed by a microprocessor or store data that may be used in arithmetic operations.

The descriptions are applicable in any computing or processing environment. The embodiments or portions thereof may be implemented in hardware, software, or a combination of the two. For example, the embodiments or portions thereof may be implemented using circuitry, such as one or more of programmable logic (e.g., an ASIC), logic gates, a processor, and a memory.

The terms and expressions that are employed herein are terms or descriptions and not of limitation. There is no intention in the use of such terms and expressions of excluding the equivalents of the feature shown or described, or portions thereof, it being recognized that various modifications are possible within the scope of the invention as claimed.

1. The computer-based method for providing feedback to suppliers, comprising the steps of:
(A) an administrative component of a system server receiving from a remote source electronically connected to the system server an indication that at least one service has been purchased by a user from a supplier;
(B) determining at the administrative component that the at least one service purchased by the user from the supplier has been completed;
(C) at the administrative component transmitting to a user input device a request for feedback with respect to the at least one service purchased by the user from the supplier;
(D) the user inputting into to the user input device feedback, including positive, neutral, or negative feedback, with respect to the at least one service purchased by the user from the supplier;
(E) transmitting from the user input device to the system server the feedback input at step (D);
(F) an application module of the system server receiving the feedback transmitted from the user input device at step (E); and
(G) a data storage module of the system server storing the feedback received by the application module at step (F) in a database electrically connected to the system server, with the feedback being tagged to a supplier file in the database.

2. The method of claim 1, further comprising:
a notifications module of the system server transmitting to a computer-based supplier device a notification that the system server received an indication of feedback with respect to the completed at least one service purchased by the user from the supplier and
a supplier access module of the system server receiving from the computer-based supplier device a response to the feedback with respect to the completed at least one service purchased by the user from the supplier.

3. The method of claim 2, further comprising:
the notifications module transmitting to the user input device of the feedback response.

4. The method of claim 2, further comprising:
the supplier access module transmitting a report to the computer-based supplier device including updated feedback according to the transmitted response.

5. The method of claim 1, wherein the user includes at least one of a direct user, an online travel agency (OTA), or a meetings management company (MMC).

6. The method of claim 1, wherein the feedback transmitted at step (E) includes being reviewed by an Auto Curation Module of the system server for quality control.

7. The method of claim 1, wherein the at least one service purchased by the user from the supplier includes at least a venue for corporate meetings.

8. A non-transitory computer-readable storage medium having stored thereon, computer executable instructions that, if executed by a computer system cause the computer system to perform a method of providing feedback to suppliers, said method comprising:
(A) an administrative component of a system server receiving from a remote source electronically connected to the system server an indication that at least one service has been purchased by a user from a supplier;
(B) determining at the administrative component that the at least one service purchased by the user from the supplier has been completed;
(C) at the administrative component transmitting to a user input device a request for feedback with respect to the at least one service purchased by the user from the supplier;
(D) the user inputting into to the user input device feedback, including positive, neutral, or negative feedback, with respect to the at least one service purchased by the user from the supplier;
(E) transmitting from the user input device to the system server the feedback input at step (D);
(F) an application module of the system server receiving the feedback transmitted from the user input device at step (E); and
(G) a data storage module of the system server storing the feedback received by the application module at step (F) in a database electrically connected to the system server, with the feedback being tagged to a supplier file in the database.

9. The non-transitory computer-readable storage medium of claim 8, wherein the method further comprises:
a notifications module of the system server transmitting to a computer-based supplier device a notification that the system server received an indication of feedback with respect to the completed at least one service purchased by the user from the supplier and
a supplier access module of the system server receiving from the computer-based supplier device a response to the feedback with respect to the completed at least one service purchased by the user from the supplier.

10. The non-transitory computer-readable storage medium of claim 9, wherein the method further comprises:
the notifications module transmitting to the user input device of the feedback response.

11. The non-transitory computer-readable storage medium of claim 9, wherein the method further comprises:
the supplier access module transmitting a report to the computer-based supplier device including updated feedback according to the transmitted response.

12. The non-transitory computer-readable storage medium of claim 8, wherein the user includes at least one of a direct user, an online travel agency (OTA), or a meetings management company (MMC).

13. The non-transitory computer-readable storage medium of claim 8, wherein the feedback transmitted at step (E) includes being reviewed by an Auto Curation Module of the system server for quality control.

14. The non-transitory computer-readable storage medium of claim 8, wherein the at least one service purchased by the user from the supplier includes at least a venue for corporate meetings.

15. A system server, comprising:
a hardware processor; and
memory coupled to the processor, with the memory including instructions that when executed cause the system server to perform a method of managing venues, the method including:
(A) an administrative component of a system server receiving from a remote source electronically connected to the system server an indication that at least one service has been purchased by a user from a supplier;
(B) determining at the administrative component that the at least one service purchased by the user from the supplier has been completed;
(C) at the administrative component transmitting to a user input device a request for feedback with respect to the at least one service purchased by the user from the supplier;
(D) the user inputting into to the user input device feedback, including positive, neutral, or negative feedback, with respect to the at least one service purchased by the user from the supplier;
(E) transmitting from the user input device to the system server the feedback input at step (D);
(F) an application module of the system server receiving the feedback transmitted from the user input device at step (E); and
(G) a data storage module of the system server storing the feedback received by the application module at step (F) in a database electrically connected to the system server, with the feedback being tagged to a supplier file in the database.

16. The system of claim 15, wherein the method further comprises:
a notifications module of the system server transmitting to a computer-based supplier device a notification that the system server received an indication of feedback with respect to the completed at least one service purchased by the user from the supplier and
a supplier access module of the system server receiving from the computer-based supplier device a response to the feedback with respect to the completed at least one service purchased by the user from the supplier.

17. The system of claim 16, wherein the method further comprises:
the notifications module transmitting to the user input device of the feedback response.

18. The system of claim 16, wherein the method further comprises:
the supplier access module transmitting a report to the computer-based supplier device including updated feedback according to the transmitted response.

19. The system of claim 15, wherein the user includes at least one of a direct user, an online travel agency (OTA), or a meetings management company (MMC).

20. The system of claim 19, wherein the feedback transmitted at step (E) includes being reviewed by an Auto Curation Module of the system server for quality control.
